(19) United States
(12) Patent Application Publication
(10) Pub. No.: US 2013/0196731 A1
(43) Pub. Date: Aug. 1, 2013

(54) NETWORK BASED CARD GAME OF SKILL

(71) Applicant: Norbert Svanascini, Chicago, IL (US)

(72) Inventor: Norbert Svanascini, Chicago, IL (US)

(21) Appl. No.: 13/647,199

(22) Filed: Oct. 8, 2012

Related U.S. Application Data
(60) Provisional application No. 61/627,284, filed on Oct. 6, 2011.

(51) Int. Cl. A63F 13/00

(52) U.S. Cl. CPC A63F 13/005
USPC 463/13; 463/11

(57) ABSTRACT

A card game of skill is a network based board game played through an interface with two or more players. The card game of skill may have the same basic rules with regards to winning hands and community cards as Texas Hold'em. Each player in has two hole cards for each hand. Rather than being dealt at random from a deck, the hole cards for each player are selected by the player from a set cards assigned to the player. A master dealer deck may also be maintained during game play and is used to provide community cards. When each player selects their hold cards, the selected hole cards are removed from a master dealer deck. Hence, cards selected by a player as hole cards will not appear as the community cards provided by a dealer for all players to see and use as part of their hand.

### BACKGROUND

Poker is a card game of chance that has been played for decades. Typically, a dealer provides cards from a deck of cards to players from a shuffled deck. Because the deck is shuffled, a user has no control over the cards received from the dealer. Dealing cards from a shuffled deck makes most poker games a game of chance, as there is no control over which cards a user will receive. It would be desirable to provide a card game that allows players to user more strategy than is currently possible in card games that provide cards from a shuffled deck.

### SUMMARY OF THE INVENTION

A card game of skill of the present invention is a network and electronic based board game played through an interface with two or more players. The card game of skill may be played over a network such as the Internet and may have the same basic rules with regards to winning hands and community cards as Texas Hold'em. It can be played in many variations, for example with as few as two people, as a single table game or tournament style. Each player in the card game of skill has two hole cards for each hand. Rather than being dealt at random from a deck, the hole cards for each player are selected by the player from a set cards assigned to the player. A master dealer deck may also be maintained during game play and is used to provide community cards. When each player selects their hold cards, the selected hole cards are removed from a master dealer deck. Hence, cards selected by a player as hole cards will not appear as the community cards provided by a dealer for all players to see and use as part of their hand. The card game of skill may follow the rules of Texas Hold'em, including use of the community cards, wagering and blinds. Once a card is selected, it cannot be played until the next round.

The present invention may provide an interface to each user playing the card game of skill. The interface may display a gaming surface, the community cards in play, wagers, and identifiers for participating players. As a player selects cards from his or her deck to be hole cards over the course of different hands within a round, a player's set of cards will be reduced. Cards played as hole cards are removed from the player's personal set of cards until all twenty-six hands are played. When selecting hole cards from a player's set of cards, a time limit may be imposed on the player's selection. If a player does not choose the two hole cards within the time limit, two cards will be randomly chosen as the hole cards.

In an embodiment, the present technology provides a method for providing a card game of skill. A set of selectable cards may be provided to a user for a first hand of a game through an interface provided by a computing device. A selection may be received from a user by the computing device of a first subset of cards from the set of selectable cards. One or more community cards may be provided through the interface during play of the game. One or more wagers may be received from the user during play of the game. A hand for the user may be determined based on the user selected subset of cards and the one or more community cards. A hand may be determined for each of one or more other players based on player selected subsets of cards and the community cards. An outcome of the game may be determined based on the determined hands for the user and the one or more players. An updated set of selectable cards may be provided to the user for the next hand of the game. The updated set of selectable cards may have the previously selected subset of cards removed from the set.

### BRIEF DESCRIPTION OF THE DRAWINGS

FIG. 1 is a block diagram of an exemplary system for providing a card game of skill.

FIG. 2 is a block diagram of an application server.

FIG. 3 is a flow chart of an exemplary method for providing a card game of skill.

FIG. 4 is an exemplary interface for providing a card game of skill.

FIG. 5 is an exemplary interface for selecting a first subset of cards.

FIG. 6 is an exemplary interface showing user selected cards.

FIG. 7 is an exemplary interface of a card game of skill in progress.

FIG. 8 is an exemplary interface for selecting a second subset of cards.

FIG. 9 is a block diagram of an exemplary computing device for implementing embodiments of the present technology.

FIG. 10 is a block diagram of an exemplary mobile device for implementing embodiments of the present technology.

### DESCRIPTION OF EXEMPLARY EMBODIMENTS

The card game of skill of the present invention is a network and electronic based board game played through an interface with two or more players. The card game of skill combines strategy elements chess with the elements of a card game such as poker. In one embodiment, the card game of skill may be played over a network such as the Internet and may have the same basic rules with regards to winning hands and community cards as Texas Hold'em. It can be played in many variations, for example with as few as two people, as a single table game or tournament style.

A strategic element of the game comes into play with the players' hole cards. Each player in the card game of skill has two hole cards for each hand. Rather than being dealt at random from a deck, the hole cards for each player are selected by the player from a set cards assigned to the player. A player's set of cards for providing hole cards may include an entire deck for each user or less than an entire deck. When the set of cards is an entire deck, each user may select two cards as the user's hole cards for each hand, for a total of twenty-six hands per round. Another number of hole cards may also be chosen in variations of the game.

A master dealer deck may also be maintained during game play and is used to provide community cards. When each player selects their hold cards, the selected hole cards are removed from a master dealer deck. Hence, cards selected by a player as hole cards will not appear as the community cards provided by a dealer for all players to see and use as part of their hand. Note, however, that two or more players may select the same card as a hole card, as all players may begin with the same set of whole cards to begin with (e.g., a full deck of cards). The card game of skill may follow the rules of Texas Hold'em, including use of the community cards, wagering and blinds. Once a card is selected, it cannot be played until the next round.

The present invention may provide an interface to each user playing the card game of skill. The interface may display a gaming surface, the community cards in play, wagers, and identifiers for participating players. For each player, the interface may provide a list of selectable action buttons. The buttons may correspond to actions a player may take during a game, such as for example fold, call, bet, leave the game, cash in, and so forth. The interface may also display, for each player, the player's current set of cards. As a player selects cards from his or her deck to be hole cards over the course of different hands within a round, a player's set of cards will be reduced. Cards played as hole cards are removed from the player's personal set of cards until all twenty-six hands are played. At the end of each hand, all cards may be replaced in the master dealer deck, and the process starts all over again for the next hand in the round. A round may consist of enough hands required to play through all the cards in each player's set of cards. When all cards in a player's set of cards have been played, the player receives another deck of personal cards, and the process is repeated until there is a winner.

When selecting hole cards from a player's set of cards, a time limit may be imposed on the player's selection, such as for example ten seconds. If a player does not choose the two hole cards within the time limit, two cards will be randomly chosen as the hole cards. This helps maintain a steady game flow and ensure that all players play the same amount of hands consecutively.

During game play, two or more players may select one or two of the same cards for a particular hand. If the same cards are picked by multiple players, the master deck will not be affected other than to have the particular hole cards removed from the deck. The players will still have to use the same strategy as a typical Texas Hold'em game concerning bluffing, betting strategies, and all other facets of the game. Obviously, if both players call having the same hand, it's a push, and they will split the pot according to well known rules of Texas Hold 'em.

By allowing each player the opportunity to select hole cards rather than dealing hole cards with random suit and values, the card game of the present technology becomes a game of skill rather than a game of chance like other poker games, such as traditional Texas Hold'em poker. Providing each player with a set of cards from which strategically select their hold cards from provides a strategic element that is drastically different from other poker games. Furthermore, the fact that each player may select the same card or same two cards for a particular hand provides another strategic element that is also not available in traditional poker games. These are just some of the features that set the card game of skill of the present technology apart from other games.

Embodiments discussed herein may refer to a Texas Hold'em poker game. Features of the present technology, including allowing a user to select hole cards from a set of cards from hand to hand, may be used with other games of poker as well as other card games. References to Texas Hold'em poker are merely for purposes of discussion.

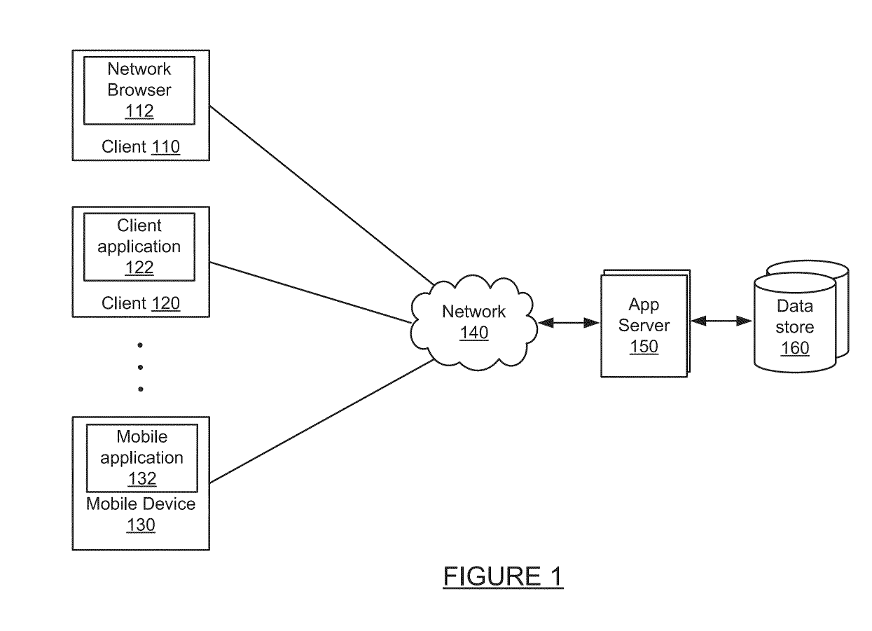

FIG. 1 is a block diagram of an exemplary system for providing a card game of skill. The system of FIG. 1 includes clients 110 and 120, mobile device 130, network 140, application server 150 and data store 160.

Clients 110 and 120 may communicate with network 140 to access a network-based card game of skill provided by application server 150. Client 110 may include network browser 112. In some embodiments, network processor 112 may render an interface provided as a webpage by application server 150 over network 140. Client 120 may include a client application 122, which may also provide an interface based on data received over network 140 from application server 150. Clients 110 and 120 may include a desktop computer, laptop computer, workstation, or other computing device.

Mobile device 130 may communicate with network 140 and include mobile application 132. Mobile application 132 may provide an interface based on data received over network 140 from application server 150. The mobile device may include a personal data assistant (PDA), smart phone, tablet computer, or other mobile device which may communicate with application server 150 over network 140, a Wi-Fi network, Bluetooth network, or other data communication networks.

Network 140 may communicate with clients 110, 120 and 130, as well as application server 150. Network 140 may include one or more private networks, public networks, local area networks, wide area networks, an intranet, the internet, Wi-Fi or other wireless data communication networks, or a combination of these networks.

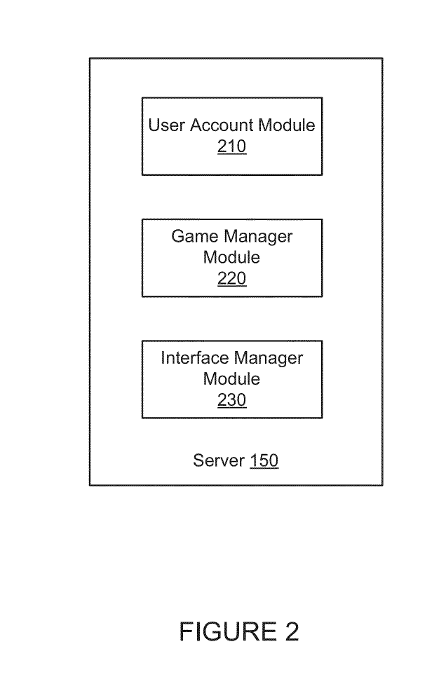

Application server 150 may include one or more servers that communicate with network 140 and may access one or more of data stores 160. The application server 150 may include one or more modules stored in memory and executable by one or more processors to provide a card game of skill over network 140 to one or more users or players at clients 110-120 and mobile device 130. Application server 150 is discussed in more detail below with respect to the block diagram of FIG. 2. Data store 160 may store user account data and other data which is retrievable by one or more modules on application server 150.

FIG. 2 is a block diagram of an application server 150. The application server 150 of FIG. 2 may include a user account module 210, game manager module 220, and an interface manager model 230. Though three modules are illustrated, additional or fewer modules may be implemented to provide the functionality discussed herein. Each module may be stored as instructions in memory of the application server and executed by one or more application server processors to perform the functionality described herein.

User account module 210 may perform administrative functions such as enabling a user to set up an account, perform a login to the account, modifying and managing the account, and other administrative functions that support providing a card game of skill provided to multiple players over a network.

Game manager module 220 may handle gaming functions associated with the card game of skill provided by the present technology. For example, game manager module may determine the order, suite and value of cards dealt by a dealer, automatically and randomly select hole cards for a user after a time for user selection has expired, determining wager and payout information for a card game of skill, determining a best hand for a user, determining a winning hand in a particular game, determine payouts for each hand, and other game tasks.

Interface manager module 230 may generate and provide an interface to clients and devices over network 140. The interface manager module may provide a virtual gaming surface or environment, images of cards displaced over the interface, action selection buttons superimposed on the playing surface, wagering icons, an real-time dialogue box, and other elements and information to the interface. The interface manager module 230 may also receive input through interface and provide the input to other modules as needed. For example, input from a player selecting two hole cards from the user's set of cards may be provided to game manager module 220 so that the user's set of cards can be updated to remove the selected cards and the main dealer deck may be updated to not include the cards.

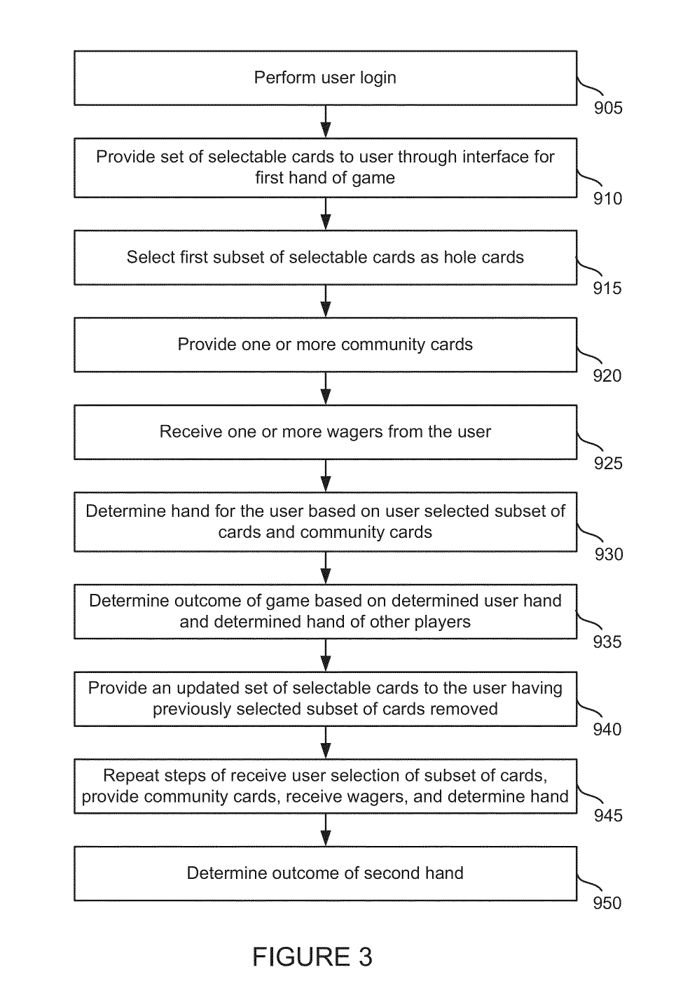

FIG. 3 is a flow chart of an exemplary method for providing a card game of skill. The method of FIG. 3 may be performed by one or more modules stored in memory of application server 150 and executed by one or more server processors. First, a user performs a login as step 905. Login may be performed by a user who has created an account with the gaming service provided by application server 150. Creating an account may include receiving a user name, password, contact information, security information and other data by application server 150 from a user through one of devices 110-130.

A set of selectable cards is provided to a user through an interface for the first hand of a game at step 910. A user's hand in each hand of the card game of skill may be made up of a number of community cards and a number of hole cards. The community cards may be used by all players, and the hole cards for each player and used only by the particular player. Unlike other games, such as the traditional poker game of Texas Hold 'em, the user's hole cards may be selected by the user from a set of cards that is continually updated as hands occur throughout the current game. The set of selectable cards may be provided within the interface via visual or audible information.

A first subset of selectable cards is selected as hold cards at step 915. The selection may be received by the user, for example by receiving input to position a cursor over a card and receiving a confirming input from the user. The user may select two cards as hole cards, or may select a different number of cards as hole cards for different variations of the card game of skill. A user may be required to provide hole cards selections within a specified period of time. If the user selection is not received within the specified period of time, such as ten seconds, the system may automatically select the hole cards at random for the user.

One or more community cards may be provided at step 920. One or more wages may be received from the user as well as other players at step 925. In some embodiments, the wagering and dealing of community cards may occur in an alternating order. For example, a first round of wagering may occur after player hole cards have been selected. Wagering may include wagering a desired amount by a player, calling by a player, raising a wager, and folding, as well as other typical game play wagering actions in typical poker-type games. After the first round of wagering, a first set of one or more community cards may be dealt within the interface. For example, the first dealing of community cards may include three community cards. After the first dealing of community cards, a second round of wagering may occur. A second round community cards may then be dealt, for example by dealing one additional community card, followed by another round of wagering. Another community card may be dealt and followed by a last round of wagering. In some embodiments, different sequences of dealing and wagering may be incorporated into the present card game of skill, as well as different numbers of community cards being dealt.

Once the community cards and wagers have been made, a hand is determined for the user based on the user selected hole cards selected at step 915 and the community cards provided at step 920. A hand for each other player participating in the current game is also determined. The outcome of the game is then determined based on the determined user hand and other player hands at step 935. The player with the best hand will win the current hand. An award is then provided to the player with the winning hand, such as the wagered bets, and a next round begins at step 940. At step 940, an updated set of selectable cards is provided to the user wherein a player's previously selected hole cards are removed from that player's set of selectable cards. For example, if during the first round of the game a user selected a king of hearts and king of diamonds, the updated set of selectable cards provided to the user at step 940 would not include the king of hearts and king of diamonds. Though a user's set of selectable cards is updated and decreases with each hand, the master deck used by a dealer may be refreshed for each hand. Thus, at the beginning of each hand, the dealer deck may start as a full deck and be reduced as users select hole cards and as community cards are dealt.

The steps of receiving a user selection, providing community cards, receiving one or more wagers, and determining hands for the user and each player is repeated at step 945 after providing the updated set of selectable cards. An outcome of the second hand is then determined at step 950. The game then continues with additional iterations of hands until a particular event occurs. In some embodiments, the event may include a number of hands, a period of time, a participating player wins all other player's money, or some other event that ends the current game.

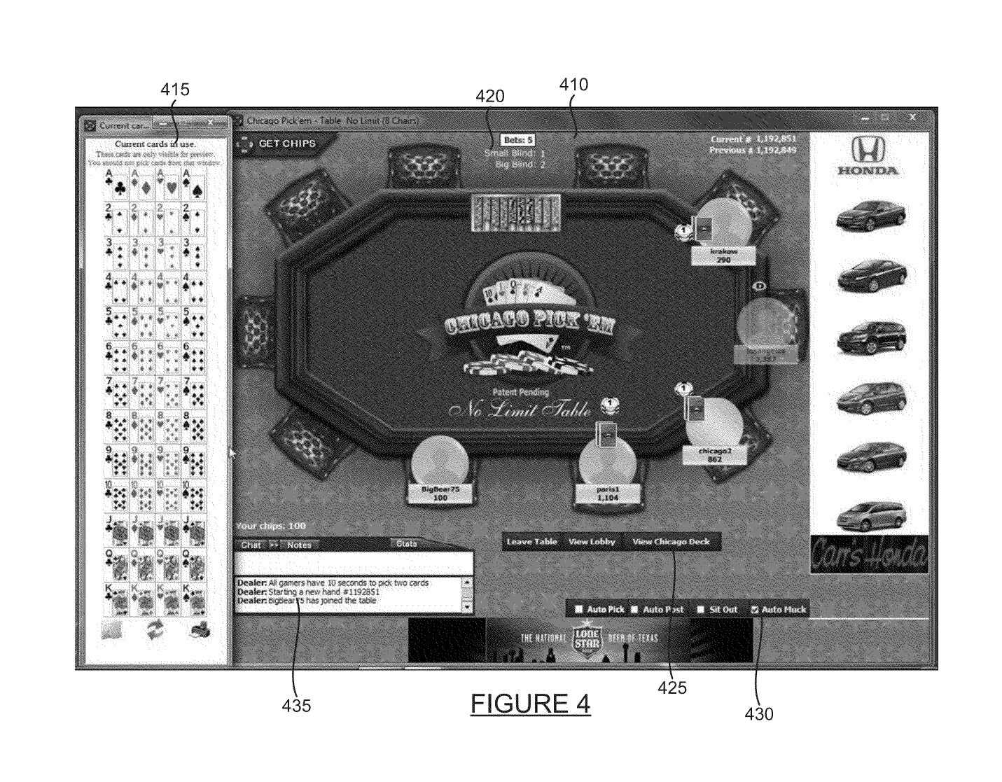

FIG. 4 is an exemplary interface for providing a card game of skill. The interface of FIG. 4 includes interface 410, current card window 415, blind information 420, first action window 425, second action window 430, and comment box 435. The current card window 415 displays the card status for the particular user, displaying cards available in future hands and the cards previously selected as hole cards. The blind information 420 indicates the small blind amount and big blind amount for the current hand.

A player may interact with other players and participate in the game by selecting various action boxes provided within interface 410. The first action box 425 provides selectable buttons for actions of leave table (end game), view lobby (view game statistics, such as money lost, time played, players playing, user account information, and other information), and view deck (current card window) for the particular user. The second action box provides buttons of auto pick, auto post, sit out and auto muck for the particular user. The auto pick action enables automatic picking of the player's hole cards. The auto post enables posting of dialogue comments in the dialog box pertaining to user actions (i.e., check, call, raise, fold, and so forth). The sit-out action button allows the user to not participate in a round of the game.

The dialogue box 440 allows users to type comments to be seen by other players. The system may provide comments automatically from the dealer, such as informing users of particular events such as the start of the game and users who have come to or left the game.

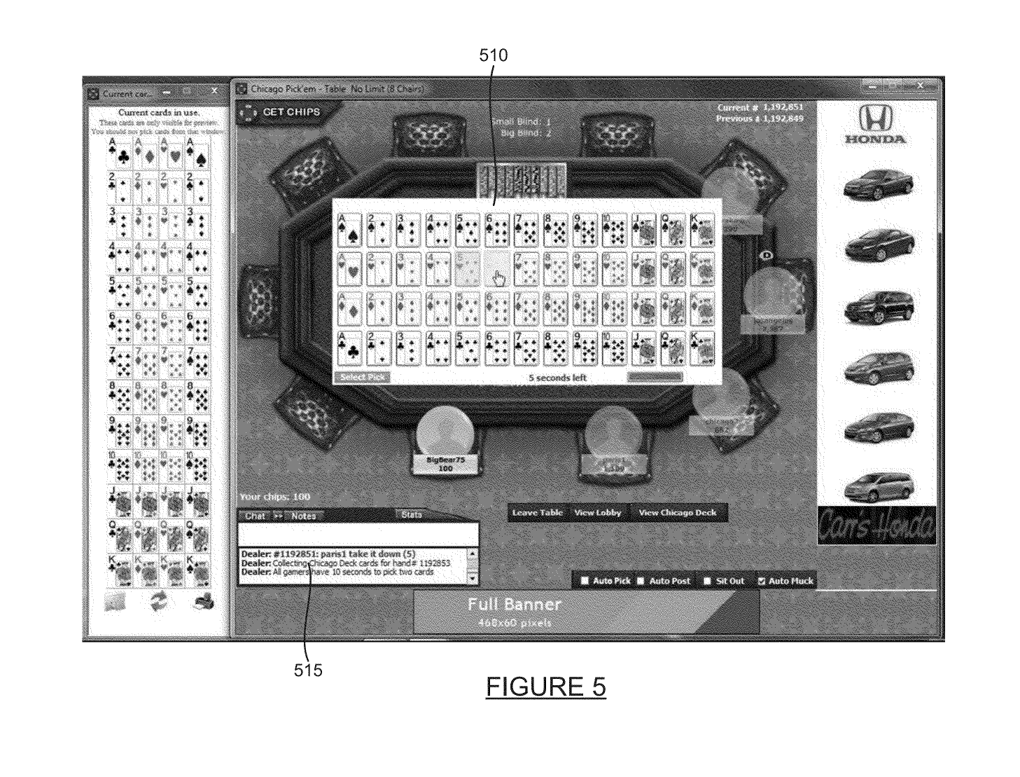

FIG. 5 is an exemplary interface for selecting a first subset of cards as hole cards. The interface at FIG. 5 includes the general interface of FIG. 4 and a selectable card window 510. As shown, the user may select hole cards to use in the present game. In the interface of FIG. 5, the user has selected the five of hearts and six of hearts as his two hole cards for the particular hand. A user may have a limited amount of time to select the cards before the system selects two cards on the user's behalf. As shown near the bottom of the selectable card window, a timer indicates that a user has currently has five seconds left to make a selections of hole cards. Dialogue box 515 indicates that each player has ten seconds to pick their two cards before cards will be picked for the user.

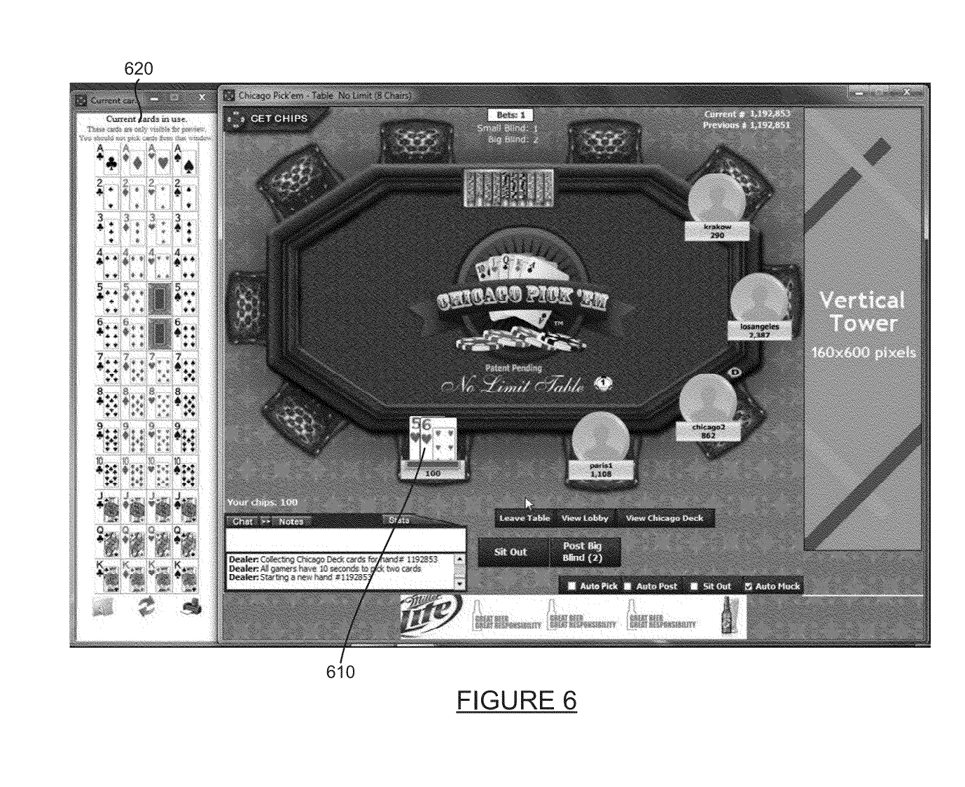

FIG. 6 is an exemplary interface showing user selected cards. In the interface of FIG. 6, the five of hearts and six of hearts are displayed at the current player's card region 610. In the current selectable card window 620, it can be seen that the five of hearts and six of hearts are missing from the list of cards, indicating that the user has selected these cards as hole cards and may not select these cards in later hands of the current round.

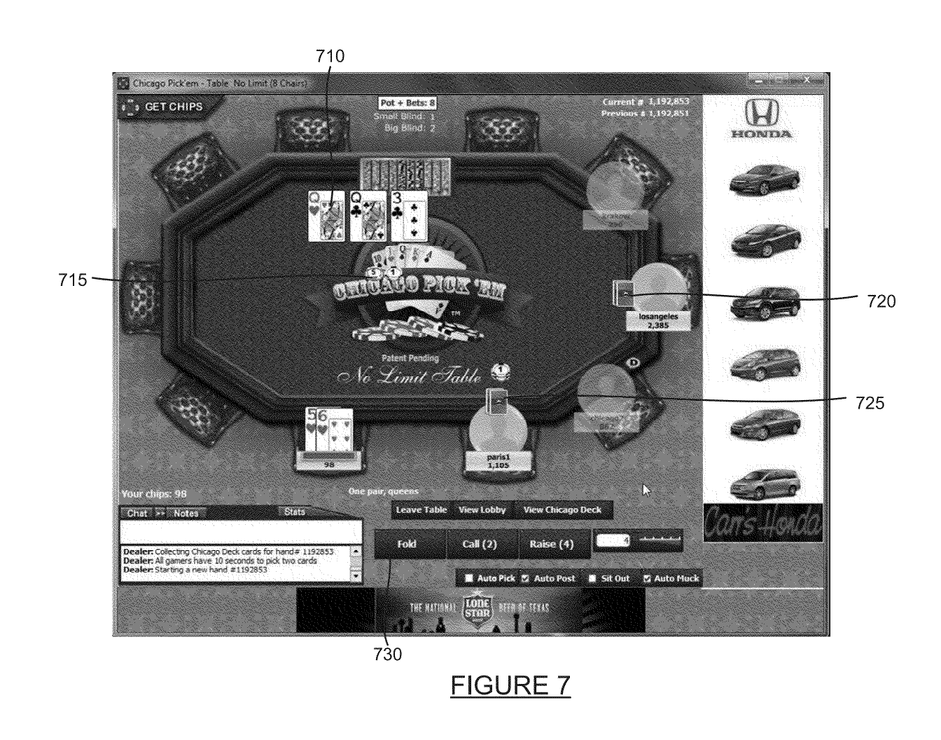

FIG. 7 is an exemplary interface of a card game of skill in progress. As seen in the interface of FIG. 7, multiple users have picked their hole cards and three community cards 710 have been displayed on the gaming surface. Wagers amounting to the amount shown at wager portion 715 have been made by the players still active in the present hand. The user has an option of performing actions such as fold, call or raise as indicated by action button 730.

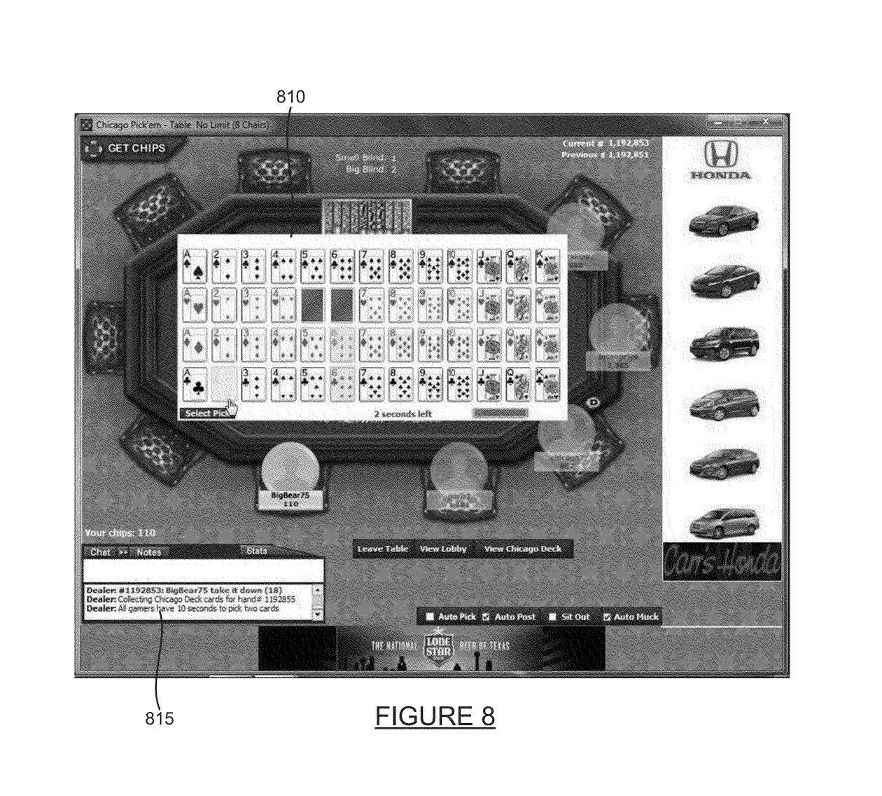

FIG. 8 is an exemplary interface for selecting a second subset of cards. After the first hand has completed and a winner has been determined, a second hand of the game may be played. When the user proceeds to select hole cards for the second hand, the cards previously selected by the user are removed from the available selectable set of cards, as shown in current selectable card window 810. For example, in window 810, the five of hearts and six of hearts are not available for the user to select. The user may only have a limited time to select hole cards, such as for example a ten second time limit as indicated in dialogue box 815.

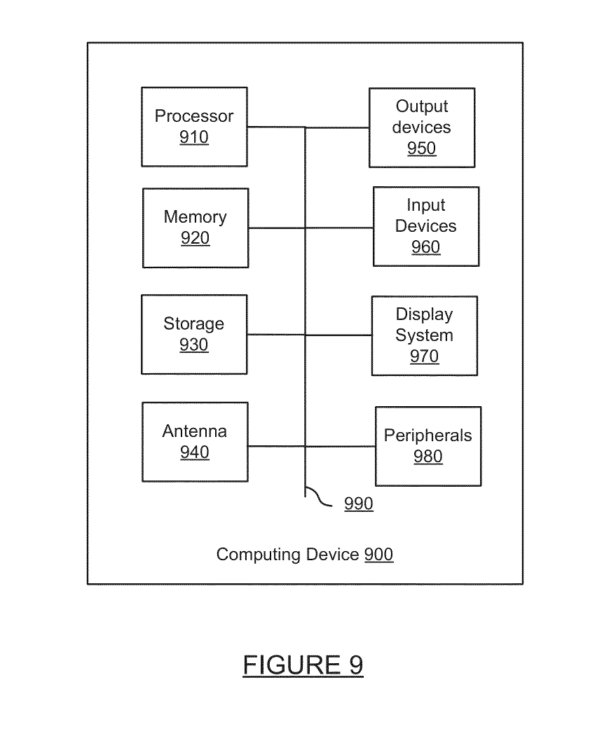

FIG. 9 is a block diagram of an exemplary computing device for implementing embodiments of the present technology. The system of FIG. 9 may be implemented in the contexts of the likes of client 110, application server 140, and data store 150. The computing system 900 of FIG. 9 includes one or more processors 910 and memory 920. Main memory 920 stores, in part, instructions and data for execution by processor 910. Main memory 920 can store the executable code when in operation. The system 900 of FIG. 9 further includes a mass storage device 930, portable storage medium drive(s) 940, output devices 950, user input devices 960, a graphics display 970, and peripheral devices 980.

The components shown in FIG. 9 are depicted as being connected via a single bus 990. However, the components may be connected through one or more data transport means. For example, processor unit 910 and main memory 920 may be connected via a local microprocessor bus, and the mass storage device 930, peripheral device(s) 980, portable storage device 940, and display system 970 may be connected via one or more input/output (I/O) buses.

Mass storage device 930, which may be implemented with a magnetic disk drive or an optical disk drive, is a non-volatile storage device for storing data and instructions for use by processor unit 910. Mass storage device 930 can store the system software for implementing embodiments of the present invention for purposes of loading that software into main memory 910.

Portable storage device 940 operates in conjunction with a portable non-volatile storage medium, such as a floppy disk, compact disk or Digital video disc, to input and output data and code to and from the computer system 900 of FIG. 9. The system software for implementing embodiments of the present invention may be stored on such a portable medium and input to the computer system 900 via the portable storage device 940.

Input devices 960 provide a portion of a user interface. Input devices 960 may include an alpha-numeric keypad, such as a keyboard, for inputting alpha-numeric and other information, or a pointing device, such as a mouse, a trackball, stylus, or cursor direction keys. Additionally, the system 900 as shown in FIG. 9 includes output devices 950. Examples of suitable output devices include speakers, printers, network interfaces, and monitors.

Display system 970 may include a liquid crystal display (LCD) or other suitable display device. Display system 970 receives textual and graphical information, and processes the information for output to the display device.

Peripherals 980 may include any type of computer support device to add additional functionality to the computer system. For example, peripheral device(s) 980 may include a modem or a router.

The components contained in the computer system 900 of FIG. 9 are those typically found in computer systems that may be suitable for use with embodiments of the present invention and are intended to represent a broad category of such computer components that are well known in the art. Thus, the computer system 900 of FIG. 9 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

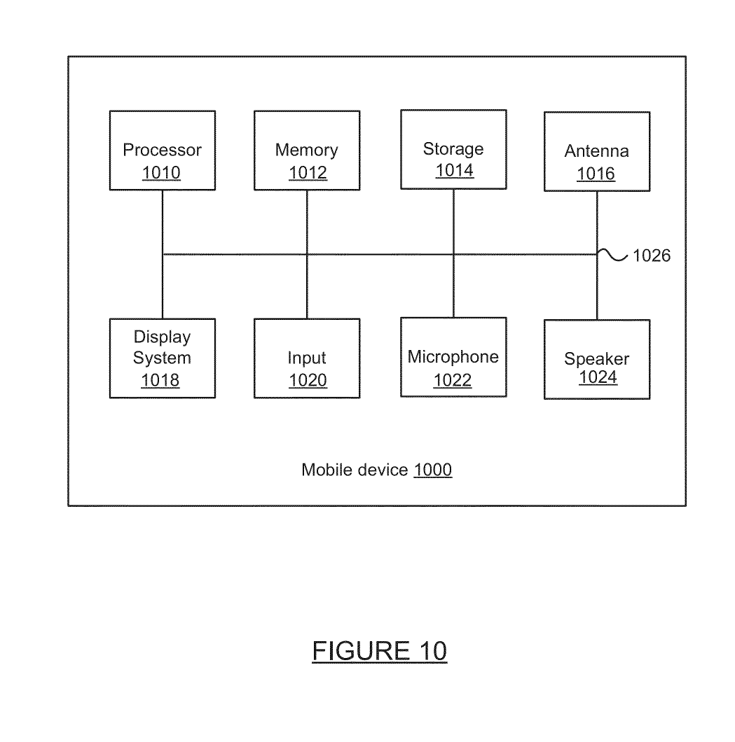

FIG. 10 is a block diagram of an exemplary mobile device for implementing embodiments of the present technology. Mobile device 1000 of FIG. 10 may be used to implement a mobile device for use with the present technology, such as for mobile device 120. The mobile device 1000 of FIG. 10 includes one or more processors 1010 and memory 1020. Memory 1020 stores, in part, programs, instructions and data for execution and processing by processor 1010. The system 1000 of FIG. 10 further includes storage 1030, one or more antennas 1040, a display system 1050, inputs 1060, one or more microphones 1070, and one or more speakers 1080.

The components shown in FIG. 10 are depicted as being connected via a single bus 1026. However, the components 1010-324 may be connected through one or more data transport means. For example, processor unit 1010 and main memory 1020 may be connected via a local microprocessor bus, and storage 1030, display system 1050, input 1060, and microphone 1070 and speaker 1080 may be connected via one or more input/output (I/O) buses.

Memory 1020 may include local memory such as RAM and ROM, portable memory in the form of an insertable memory card or other attachment (e.g., via univerisal serial bus), a magnetic disk drive or an optical disk drive, a form of FLASH or PROM memory, or other electronic storage medium. Memory 1020 can store the system software for implementing embodiments of the present invention for purposes of loading that software into main memory 1010.

Antenna 1040 may include one or more antennas for communicating wirelessly with another device. Antenna 1040 may be used, for example, to communicate wirelessly via Wi-Fi, Bluetooth, with a cellular network, or with other wireless protocols and systems. The one or more antennas may be controlled by a processor 1010, which may include a controller, to transmit and receive wireless signals. For example, processor 1010 execute programs stored in memory 1020 to control antenna 1040 transmit a wireless signal to a cellular network and receive a wireless signal from a cellular network.

Display system 1050 may include a liquid crystal display (LCD), a touch screen display, or other suitable display device. Display system 1070 may be controlled to display textual and graphical information and output to text and graphics through a display device. When implemented with a touch screen display, the display system may receive input and transmit the input to processor 1010 and memory 1020.

Input devices 1060 provide a portion of a user interface. Input devices 1060 may include an alpha-numeric keypad, such as a keyboard, for inputting alpha-numeric and other information, buttons or switches, a trackball, stylus, or cursor direction keys.

Microphone 1070 may include one or more microphone devices which transmit captured acoustic signals to processor 1010 and memory 1020. The acoustic signals may be processed to transmit over a network via antenna 1040.

Speaker 1080 may provide an audio output for mobile device 1000. For example, a signal received at antenna 1040 may be processed by a program stored in memory 1020 and executed by processor 1010. The output of the executed program may be provided to speaker 1080 which provides audio. Additionally, processor 1010 may generate an audio signal, for example an audible alert, and output the audible alert through speaker 1080.

The mobile device system 1000 as shown in FIG. 10 may include devices and components in addition to those illustrated in FIG. 10. For example, mobile device system 1000 may include an additional network interface such as a universal serial bus (USB) port.

The components contained in the computer system 1000 of FIG. 10 are those typically found in mobile device systems that may be suitable for use with embodiments of the present invention and are intended to represent a broad category of such mobile device components that are well known in the art. Thus, the computer system 1000 of FIG. 10 can be a cellular phone, smart phone, hand held computing device, minicomputer, or any other computing device. The mobile device can also include different bus configurations, networked platforms, multi-processor platforms, etc. Various operating systems can be used including Unix, Linux, Windows, Macintosh OS, Google OS, Palm OS, and other suitable operating systems.

The present technology is described above with reference to exemplary embodiments. It will be apparent to those skilled in the art that various modifications may be made and other embodiments can be used without departing from the broader scope of the present technology. Therefore, these and other variations upon the exemplary embodiments are intended to be covered by the present technology.

What is claimed is:

1. A method for providing a card game of skill, the method comprising:
providing a set of selectable cards to a user for a first hand of a game through an interface provided by a computing device;
receiving a selection from a user by the computing device of a first subset of cards from the set of selectable cards;
providing one or more community cards through the interface during play of the game;
receiving one or more wagers from the user during play of the game;
determining a hand for the user based on the user selected subset of cards and the one or more community cards;
determining a hand for each of one or more other players based on player selected subsets of cards and the community cards;
determining an outcome of the game based on the determined hands for the user and the one or more players; and
providing an updated set of selectable cards to the user for the next hand of the game, the updated set of selectable cards having the previously selected subset of cards removed from the set.

2. The method of claim 1, wherein the set of selectable cards includes a full deck of cards.

3. The method of claim 1, wherein the user selection includes two cards from the set of selectable cards.

4. The method of claim 1, wherein the community cards include five community cards.

5. The method of claim 1, further comprising maintaining a dealer deck for each hand of the game that results in an outcome, the dealer deck reduced by each of the community cards and the user selected cards.

6. The method of claim 1, further comprising receiving input from a user to call, raise or fold.

7. The method of claim 1, further comprising providing a display of the set of selectable cards for a user.

8. The method of claim 7, wherein the display of the set of selectable cards provides a visual indicator for each available card and an unavailable indicator for each card previously selected by the user.

9. The method of claim 1, wherein the game is a virtual game of poker wherein the users first two cards are the user selected cards.

10. The method of claim 1, further comprising creating an account for the user.

11. The method of claim 1, further comprising performing login for a user.

12. The method of claim 1, further comprising receiving a selection of virtual currency by a computer from a user to begin participation in the game.

13. A computer readable storage medium having embodied thereon a program, the program being executable by a processor to perform a method for providing a card game of skill, the method comprising:
providing a set of selectable cards to a user for a first hand of a game through an interface provided by a computing device;
receiving a selection from a user by the computing device of a first subset of cards from the set of selectable cards;
providing one or more community cards through the interface during play of the game;
receiving one or more wagers from the user during play of the game;
determining a hand for the user based on the user selected subset of cards and the one or more community cards;
determining a hand for each of one or more other players based on player selected subsets of cards and the community cards;
determining an outcome of the game based on the determined hands for the user and the one or more players; and
providing an updated set of selectable cards to the user for the next hand of the game, the updated set of selectable cards having the first subset of user selected cards removed from the set.

14. The method of claim 13, wherein the set of selectable cards includes a full deck of cards.

15. The method of claim 13, wherein the user selection includes two cards from the set of selectable cards.

16. The method of claim 13, wherein the community cards include five community cards.

17. The method of claim 13, further comprising maintaining a dealer deck for each hand of the game that results in an outcome, the dealer deck reduced by each of the community cards and the user selected cards.

18. The method of claim 13, further comprising receiving input from a user to call, raise or fold.

19. The method of claim 13, further comprising providing a display of the set of selectable cards for a user.

20. The method of claim 19, wherein the display of the set of selectable cards provides a visual indicator for each available card and an unavailable indicator for each card previously selected by the user.

21. The method of claim 13, wherein the game is a virtual game of poker wherein the users first two cards are the user selected cards.

22. The method of claim 13, further comprising creating an account for the user.

23. The method of claim 13, further comprising performing login for a user.

24. The method of claim 13, further comprising receiving a selection of virtual currency by a computer from a user to begin participation in the game.
